(19) United States
(12) Patent Application Publication
(10) Pub. No.: US 2013/0168283 A1
(43) Pub. Date: Jul. 4, 2013

(54) ENVIRONMENTALLY FRIENDLY BAGS FOR MARKETING

(71) Applicant: Kamyar KASHANI, Los Angeles, CA (US)

(72) Inventor: Kamyar KASHANI, Los Angeles, CA (US)

(21) Appl. No.: 13/679,929

(22) Filed: Nov. 16, 2012

Related U.S. Application Data
(60) Provisional application No. 61/560,760, filed on Nov. 16, 2011.

(51) Int. Cl. B65D 33/00; B31B 49/04

(52) U.S. Cl. CPC B65D 33/00; B31B 49/04
USPC 206/459.5; 493/187

(57) ABSTRACT

Provided is a method for providing environmentally friendly bags to retailers for providing to consumers.

### CROSS-REFERENCE

The present application claims the benefit of U.S. provisional application No. 61/560,760, filed on Nov. 16, 2012, which is incorporated herein by reference in its entirety.

### BACKGROUND SECTION OF THE INVENTION

Plastic disposable bags, particularly those given out by supermarkets, are non-degradable and fill up the landfills. These bags are not recyclable and contaminate the oceans and water resources. Many jurisdictions are enacting laws to ban plastic disposable bags altogether. The ban on plastic bags however does not solve the need of a consumer who needs bags after shopping. There is a need in the art to provide consumers environmentally friendly bags at a reasonable cost.

### SUMMARY SECTION OF THE INVENTION

Provided is a method for providing environmentally friendly bags to consumers comprising, a) a consumer, b) a retailer that provides the consumer an environmentally friendly bag for placing goods that the consumer has purchased; c) a marketer, d) an advertiser that advertises on the bags, wherein the marketer provides bags to the retailer at reduced or no cost to be given to consumers by the retailer, wherein the advertiser pays for some or all cost of the bag to place an advertisement on the bag. The marketer can manufacture the bags, print the advertisement on the bag and ship the bags to the retailer. The marketer can outsource to another party all the manufacturing, printing, and shipping. At least a portion of the method can be automated by having a database from which an advertiser can choose the retailer or the bag. The marketer can carry out a conflict check to avoid having conflicting advertisements on the same bag or in the same retailer (or retail chain). The bag can comprise two or more advertisements. The bag can comprise three to five advertisements on same side. The bag can comprise six to ten advertisements on same side. The bag can have advertisements on different sides, with the different sides having same or different number of advertisements. Each advertisement can fill a rectangular space. Two or more advertisements can exist on the same bag, with at least two different advertisements from different advertiser in one embodiment. Two or more advertisements can exist on the same bag and all the advertisements can be by the same advertiser.

Provided is a method for providing environmentally friendly bags to consumers comprising, a) a consumer; b) a retailer that provides the consumer an environmentally friendly bag for placing goods that the consumer has purchased; c) an advertiser that advertises on the bags; wherein the advertiser provides bags to the retailer at reduced or no cost to be given to consumers by the retailer, wherein the advertiser pays for some or all cost of the bag to place an advertisement on the bag.

Provided is an environmentally friendly bag that is supplied by a retailer to a consumer that purchases a good at the retailer comprising two or more advertisements on the environmentally friendly bag. The bag can have three to five advertisements on same side of the bag. The bag can have has six to ten advertisements on same side of the bad. The bag can have advertisements on different sides, with different sides having same or different number of advertisements. Each advertisement can fill a rectangular space. Two or more advertisements can exist on the same bag, with at least two different advertisements by the same advertiser. Each advertisement can be by a different advertiser.

### BRIEF DESCRIPTION OF THE FIGURES

FIG. 1 is a schematic diagram showing the manufacturing of bags, bags are printed on, bags are wrapped and shipped, bags are distributed to consumers.

FIG. 2 is a schematic diagram showing a method of advertising that entails retailers, marketer, and advertisers.

FIG. 3A is the illustration of a bag with different advertisements.

FIG. 3B is the illustration of a bag with different advertisements.

FIG. 3C is the illustration of a bag with different advertisements.

FIG. 3D is the illustration of a bag with different advertisements.

FIG. 3E is the illustration of a bag with different advertisements.

FIG. 3F is the illustration of a bag with different advertisements.

FIG. 3G is the illustration of a bag with different advertisements.

FIG. 3H is the illustration of a bag with different advertisements.

FIG. 4 is an illustration of using a database to place an order for advertisement or receiving information from the retailer.

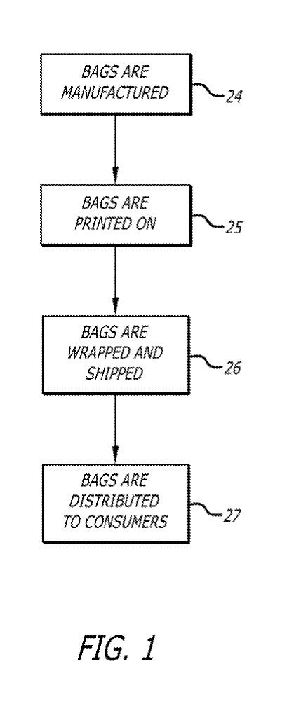

### DETAILED DESCRIPTION SECTION OF THE INVENTION

The present invention provides eco-friendly reusable bags for supermarkets and other retailers for free or reduced cost. The bags are sponsored by companies who advertise and promote their services and products on the bags.

The environmentally friendly bags (21) can be either: 1) disposable (one time use) bag (21) made from bio-degradable material; 2) reusable bag (21) made from bio-degradable or non-biodegradable material.

Examples of the first bag (21) include bags made from bio-degradable plastic. Biodegradable plastics include those made from plants, such as from biodegradable corn material. These bags are relative thin and tear easily. While these bags can theoretically be used more than once, their thin and vulnerable nature makes them suitable for one time use. These bags (21) can also be recycled.

Examples of the second bag (21) include canvass bags, cotton bags, recyclable bags, totes bags, bio-degradable bags, woven bags, non-woven bags, grocery bags, marketing bags, and organic bags.

The bags (21) are distributed to a consumer (23) at no cost or reduced cost and is sponsored by the advertiser (16) who want to promote their products.

The bags (21) can come in different shapes, forms, styles, sizes and material. They can be used for grocery stores, super markets, electronic stores, warehouse style retailers, clothing stores, department stores, toy stores, drug stores, and hardware stores.

Each bag (21) is manufactured (24) and then the logos or other information of the sponsors would be printed (25) on the bags. Each bag (21) can have a minimum of one logo (sponsor) and up to about 8 logos (or more depending on a specific embodiment) depending on the size and the shape of the bag. The logos can go on one or more of side of the bags, the front, the back, the right side, the left side or all the sides (A typical bag has four sides, with a front, back, and two “sides.” A bag can also have only two sides, i.e., a front and back). After the bags are manufactured the logo or other information can be screen printed, heat transferred, paper printed, digital print, grafted, embroider or with other methods put on the bags (25). The bags (21) can then be checked for quality control and wrapped (26) to be shipped to the retailer/distributor.

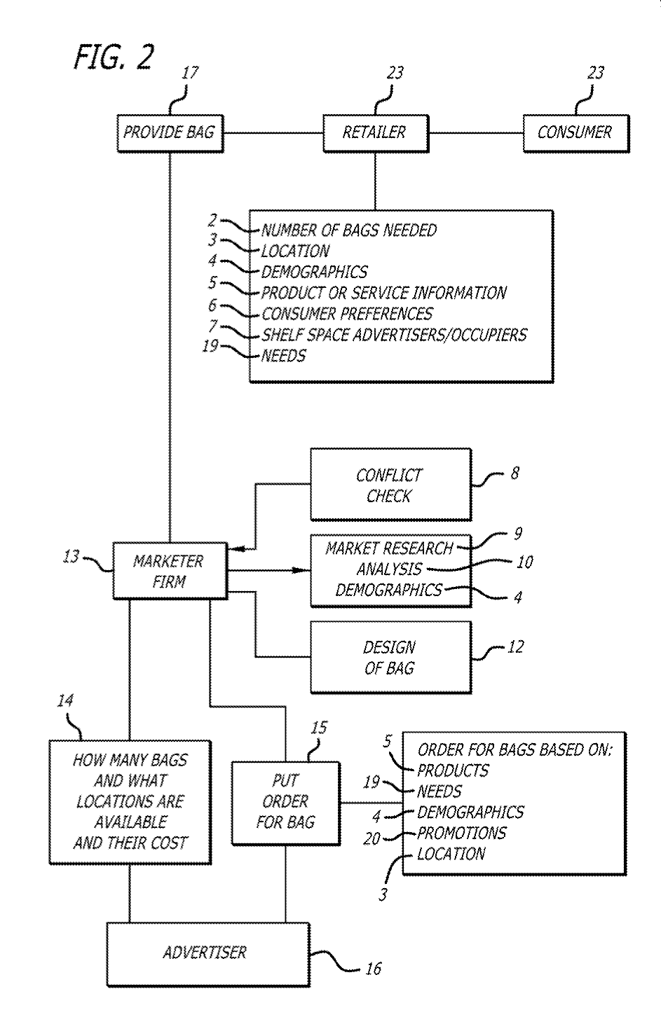

In one embodiment, a marketer (13) brings together one or more retailers (1) and one or more advertisers (16) together. As illustrated in FIG. 2, a retailer (1) can provide information and data to the marketer so that the marketer can better market the retailer to supervisors. Such information or data can include the number of bags needed (2), location of the retailer (3), demographics of the consumers (4), product or services information (5), consumer preferences (6), shelf space for advertisers/occupiers (7), and other needs of the retailer (19). The marketer (13) can also do its own research on the market (9), analysis of the data (10), and analysis of the demographics (4). The marketer (13) can design (12) the bag per need of the retailer and/or advertiser. The marketer (13) can also make sure there is no conflict (8) with two similar products promoted in the same retailer.

The advertiser (16) and the marketer (13) can work in different fashions. In one embodiment, the marketer (13) informs the advertiser (16) of availability of bags (21) and their location for advertisement (14). Based on this information (14), the advertiser (16) picks the number of bags and locations. This process can be automated where the marketer (13) has an updated database (30) for availability of bags, and the advertiser (16) can access (28) that database and pick the bags and pays for them. The retailer (1) can also access (28) the same database (30) to input information on the need for bags. A user friendly website can be used to access the database (30) with an internet connection (28).

In another embodiment, the advertiser (16) puts an order or request for bags (21) based on products and services (5), needs (19), demographics (4), promotions (20), and locations (3). The marketer (13) matches the needs of the advertiser (16) with the availability from retailer (1). This can also be automated with use of a database (30). A communication network (28) such as the internet can connect the marketer (13) to the retailer (1) and the advertiser (16).

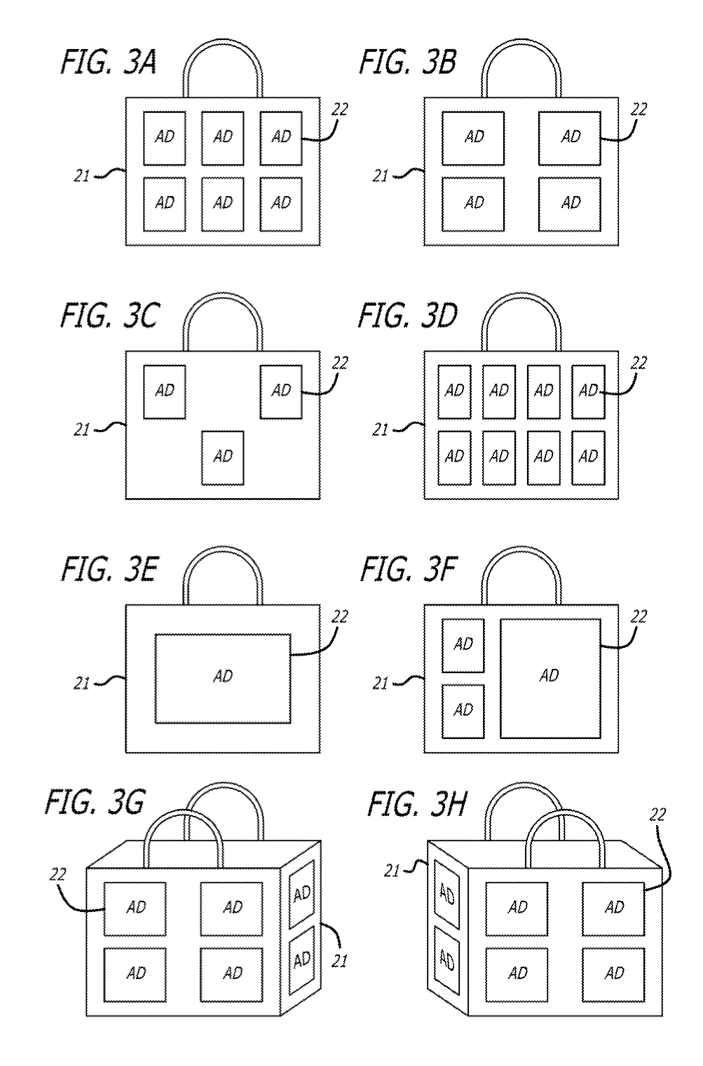

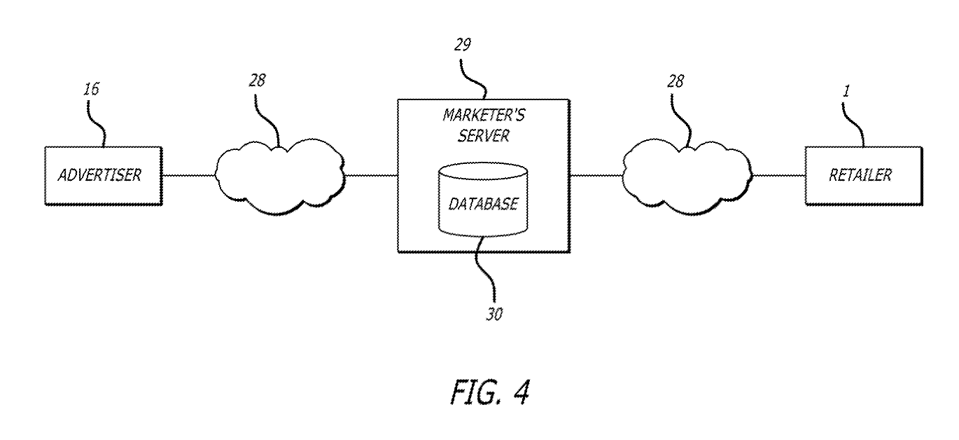

FIGS. 3A-3H illustrates the bags (21) with one or more advertisements (22) on the same or different sides. Advertising space can be sold so that multiple advertisements are placed on one bag, even on the same side. Each advertisement can be from about 2 inches×2 inches to about 14 inches×14 inches, ore more depending on the bag. The advertisement space can be rectangular (22) in shape, with multiple rectangular advertisements next to each other.

Provided is a bag having multiple advertising spaces that are sold individually or in group. Different advertisers can promote their products and services on the same side of the bag (21), thus reducing the overall cost to the advertiser. In one embodiment, about 2-10 rectangular or square portions of the bag on the same side are sold to different advertisers. Some of the advertisers can be featured more prominently that others by varying the sizes of the rectangles and squares. Other forms other than squares and rectangles can also be used.

In another embodiment, the advertiser and the retailer work without the marketer. In this embodiment, the advertiser can carry out the functions of the marketer (8), (9), (10), (12). The retailer and the advertiser would be in direct communication.

What is claimed is:

1. A method for providing environmentally friendly bags to consumers comprising,
a) a consumer;
b) a retailer that provides the consumer an environmentally friendly bag for placing goods that the consumer has purchased;
c) a marketer;
d) an advertiser that advertises on the bags;
wherein the marketer provides bags to the retailer at reduced or no cost to be given to consumers by the retailer, wherein the advertiser pays for some or all cost of the bag to place an advertisement on the bag.

2. The method of claim 1, wherein the marketer manufactures the bags, prints the advertisement on the bag and ships the bags to the retailer.

3. The method of claim 2, wherein the marketer outsources to another party all the manufacturing, printing, and shipping.

4. The method of claim 1, wherein at least a portion of the method is automated by having a database from which an advertiser can choose the retailer or the bag.

5. The method of claim 1, wherein the marketer carries out a conflict check to avoid having conflicting advertisements on the same hag or in the same retailer (or retail chain).

6. The method of claim 1, wherein the bag comprises two or more advertisements.

7. The method of claim 1, wherein the bag comprises three to five advertisements on same side of the bag.

8. The method of claim 1, wherein the bag comprises six to ten advertisements on same side of the bag.

9. The bag of claim 1, wherein the bag has advertisements on two or more sides, with each sides having same or different number of advertisements.

10. The bag of claim 1, wherein each advertisement fills a rectangular space.

11. The bag of claim 1, wherein two or more advertisements exist on the same bag, wherein at least two different advertisements are from two different advertisers.

12. The bag of claim 1, wherein two or more advertisements exist on the same bag and all the advertisements are by the same advertiser.

13. A method for providing environmentally friendly bags to consumers comprising,
a) a consumer;
b) a retailer that provides the consumer an environmentally friendly bag for placing goods that the consumer has purchased;
c) an advertiser that advertises on the bags;
wherein the advertiser provides bags to the retailer at reduced or no cost to be given to consumers by the retailer, wherein the advertiser pays for some or all cost of the bag, to place an advertisement on the bag.

14. An environmentally friendly hag that is supplied by a retailer to a consumer that purchases a good at the retailer comprising two or more advertisements on the environmentally friendly bag.

15. The bag of claim 14, wherein the bag has three to five advertisements on same side of the bag.

16. The bag of claim 14, wherein the bag has six to ten advertisements on same side of the bag.

17. The bag of claim 14, wherein the bag has advertisements on more than one side.

18. The bag of claim 14, wherein each advertisement fills a rectangular space.

19. The hag of claim 14, wherein two or more advertisements exist on the same bag, wherein each advertisement is by the same advertiser.

20. The bag of claim 14, wherein each advertisement is by a different advertiser.
